(19) United States
(12) Patent Application Publication
(10) Pub. No.: US 2022/0032379 A1
(43) Pub. Date: Feb. 3, 2022

(54) THREE-DIMENSIONAL FABRICATION APPARATUS

(71) Applicant: Ricoh Company, Ltd., Tokyo (JP)

(72) Inventors: Yasuyuki YAMASHITA, Kanagawa (JP); Tomoki KAI, Kanagawa (JP); Yasutomo AMAN, Kanagawa (JP)

(73) Assignee: Ricoh Company, Ltd., Tokyo (JP)

(21) Appl. No.: 17/374,092

(22) Filed: Jul. 13, 2021

(30) Foreign Application Priority Data
Jul. 31, 2020 (JP) 2020-131008

(51) Int. Cl. B22F 12/63; B22F 12/00; B22F 12/53; B22F 10/14; B22F 1/00; B33Y 30/00

(52) U.S. Cl. CPC B22F 12/63; B22F 12/224; B22F 12/222; B33Y 30/00; B22F 10/14; B22F 1/0059; B22F 12/53

(57) ABSTRACT

A three-dimensional fabrication apparatus includes a fabrication chamber and a roller. Powder is spread in layers in the fabrication chamber. Fabrication layers are formed of the powder bonded together and laminated in the fabrication chamber. The roller flattens the powder in the fabrication chamber. The roller includes a first helical groove region and a second helical groove region. The first helical groove region includes a first groove that moves the powder in the fabrication chamber in a first direction along a longitudinal axis of the roller as the roller rotates. The second helical groove region includes a second groove moves the powder in the fabrication chamber in a second direction opposite to the first direction as the roller rotates.

### CROSS-REFERENCE TO RELATED APPLICATION

This patent application is based on and claims priority pursuant to 35 U.S.C. § 119(a) to Japanese Patent Application No. 2020-131008, filed on Jul. 31, 2020, in the Japan Patent Office, the entire disclosure of which is hereby incorporated by reference herein.

### BACKGROUND

### Technical Field

Aspects of the present disclosure relate to a three-dimensional fabrication apparatus.

### Description of the Related Art

A three-dimensional fabrication apparatus uses, for example, additive manufacturing to fabricate a solid (three-dimensional) object. The three-dimensional fabrication apparatus forms a powder layer in a fabrication chamber. The powder layer is formed of metal or nonmetal powder which is flattened in the fabrication chamber. Then, the three-dimensional fabrication apparatus discharges fabrication liquid onto the powder layer to form a layered object (fabrication layer) in which the powder is bonded together. The three-dimensional fabrication apparatus forms a powder layer again on the fabrication layer thus formed, discharges the fabrication liquid again to the powder layer, and repeats such a process to form the fabrication layers. As a result, multiple fabrication layers are sequentially laminated to fabricate the three-dimensional object.

Here, the three-dimensional fabrication apparatus using the additive manufacturing includes a recoater roller. The recoater roller scrapes off and flattens powder in the fabrication chamber (scraping process). In such a scraping process, the powder more than needed is supplied in the fabrication chamber, and the recoater roller scrapes the powder from the fabrication chamber to evenly smooth the surface of the powder in the fabrication chamber. Surplus powder generated in the scraping process falls into a collection chamber.

### SUMMARY

Embodiments of the present disclosure describe an improved three-dimensional fabrication apparatus that includes a fabrication chamber and a roller. Powder is spread in layers in the fabrication chamber. Fabrication layers are formed of the powder bonded together and laminated in the fabrication chamber. The roller flattens the powder in the fabrication chamber. The roller includes a first helical groove region and a second helical groove region. The first helical groove region includes a first groove that moves the powder in the fabrication chamber in a first direction along a longitudinal axis of the roller as the roller rotates. The second helical groove region includes a second groove that moves the powder in the fabrication chamber in a second direction opposite to the first direction as the roller rotates.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic plan view of a three-dimensional fabrication apparatus according to a first embodiment;

FIG. 2 is a schematic side view of the three-dimensional fabrication apparatus according to the first embodiment;

FIG. 3 is a cross-sectional view of a fabrication section included in the three-dimensional fabrication apparatus according to the first embodiment;

FIG. 4 is a perspective view of a part of the three-dimensional fabrication apparatus according to the first embodiment;

FIG. 5 is a perspective view of the fabrication section included in the three-dimensional fabrication apparatus according to the first embodiment;

FIG. 6 is a block diagram illustrating the three-dimensional fabrication apparatus according to the first embodiment;

FIGS. 7A to 7E are schematic views illustrating an operation of fabricating a three-dimensional object in the three-dimensional fabrication apparatus according to the first embodiment;

FIG. 8 is a perspective view of a flattening roller of the three-dimensional fabrication apparatus according to the first embodiment;

FIG. 9 is a schematic view illustrating a state in which a flattening roller without a groove according to a first comparative example flattens powder;

FIG. 10 is a schematic view illustrating a fabrication chamber in which powder fills the center portion and runs short near the left and right ends when the flattening roller according to the first comparative example flattens the powder;

FIG. 11 is a perspective view of a flattening roller according to a second comparative example;

FIG. 12 is a schematic view illustrating a state in which the flattening roller of the three-dimensional fabrication apparatus according to a fifth embodiment flattens powder;

FIG. 13 is a perspective view of a flattening roller of the three-dimensional fabrication apparatus according to a second embodiment;

FIG. 14 is a perspective view of a flattening roller of the three-dimensional fabrication apparatus according to a third embodiment;

FIG. 15 is a perspective view of a flattening roller of the three-dimensional fabrication apparatus according to a fourth embodiment;

FIG. 16 is a perspective view of a flattening roller of the three-dimensional fabrication apparatus according to the fifth embodiment;

FIG. 17 is a perspective view of a flattening roller of the three-dimensional fabrication apparatus according to a sixth embodiment; and

FIG. 18 is a perspective view of a flattening roller of the three-dimensional fabrication apparatus according to a seventh embodiment.

The accompanying drawings are intended to depict embodiments of the present disclosure and should not be interpreted to limit the scope thereof. The accompanying drawings are not to be considered as drawn to scale unless explicitly noted. In addition, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

As used herein, the singular forms “a,” “an,” and “the” are intended to include the plural forms as well, unless the context clearly indicates otherwise.

Hereinafter, a solid (three-dimensional) fabrication apparatus according to embodiments of the present disclosure is described. The three-dimensional fabrication apparatus uses, for example, additive manufacturing to fabricate a solid (three-dimensional) object.

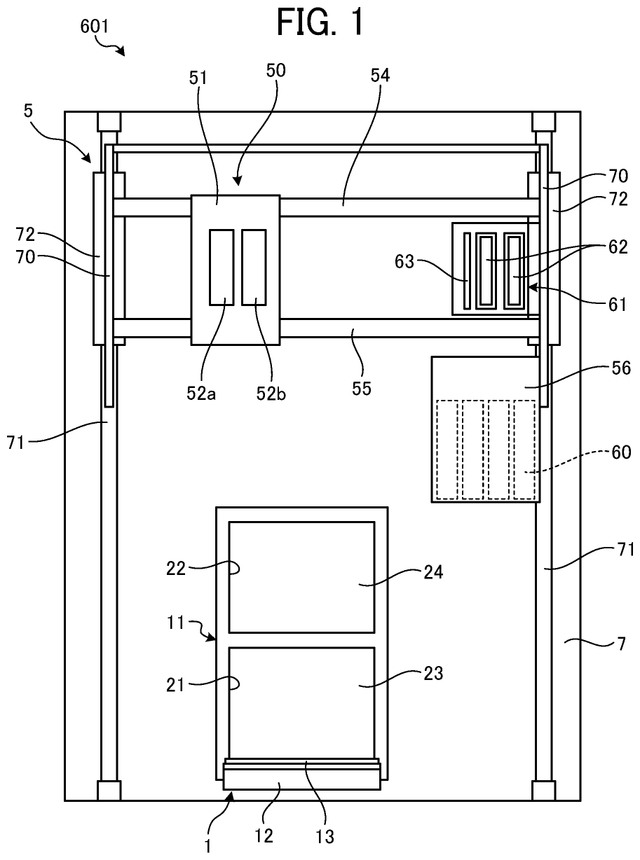

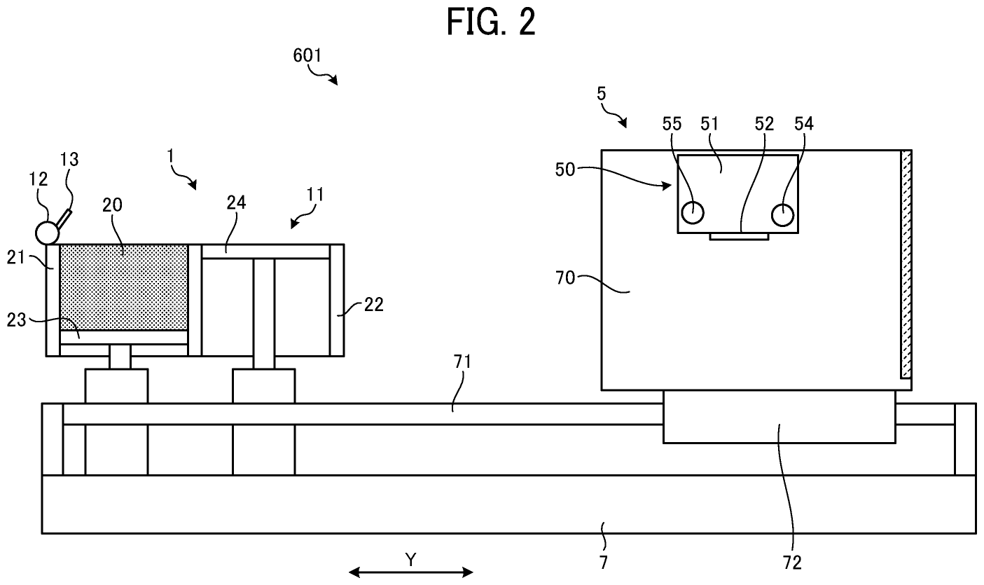

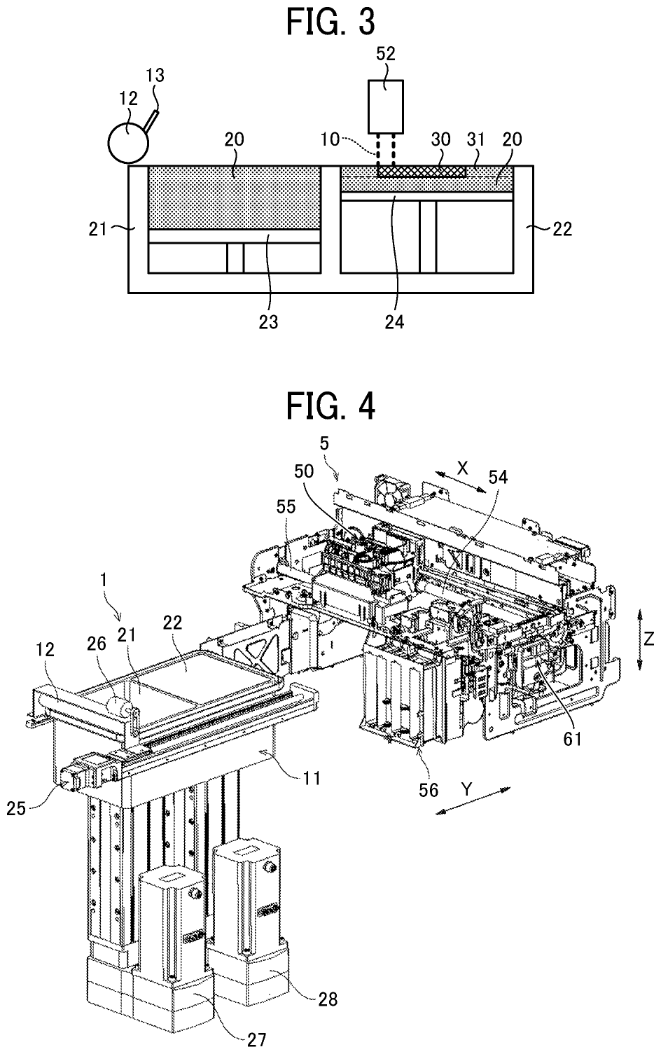

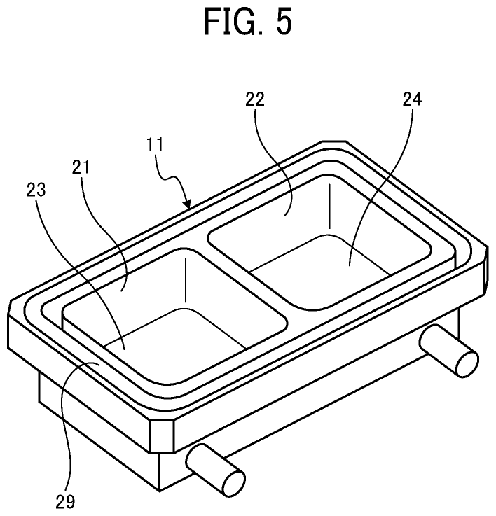

A first embodiment is described below. FIG. 1 is a schematic plan view of a three-dimensional fabrication apparatus 601 according to the first embodiment. FIG. 2 is a schematic side view of the three-dimensional fabrication apparatus 601 according to the first embodiment. FIG. 3 is a cross-sectional view of a fabrication section 1 included in the three-dimensional fabrication apparatus 601 according to the first embodiment. Note that FIG. 3 illustrates a state in which a three-dimensional object is fabricated. FIG. 4 is a perspective view of a part of the three-dimensional fabrication apparatus 601 according to the first embodiment. FIG. 5 is a perspective view of the fabrication section 1 included in the three-dimensional fabrication apparatus 601 according to the first embodiment.

The three-dimensional fabrication apparatus 601 according to the first embodiment includes the fabrication section 1 in which a fabrication layer 30 is formed. The fabrication layer 30 is a layered object formed of bonded powder such as coating powder. The three-dimensional fabrication apparatus 601 further includes a fabrication unit 5. The fabrication unit 5 discharges fabrication liquid 10 onto a powder layer 31 spread in layers in the fabrication section 1 to fabricate a three-dimensional object.

The fabrication section 1 includes a powder chamber 11 and a flattening roller 12. The flattening roller 12 is a rotator serving as a flattening member (recoater). The flattening member may be, for example, a plate member (blade) instead of the rotator. The powder chamber 11 includes a supply chamber 21 to supply powder 20 and a fabrication chamber 22 in which fabrication layers 30 are laminated to fabricate a three-dimensional object. A bottom portion of the supply chamber 21 is movable in a vertical direction (height direction) as a supply stage 23. Similarly, a bottom portion of the fabrication chamber 22 is movable in the vertical direction (height direction) as a fabrication stage 24. The fabrication layers 30 are laminated on the fabrication stage 24, and a three-dimensional object including the fabrication layers 30 is fabricated on the fabrication stage 24. For example, as illustrated in FIG. 4, a motor 27 moves the supply stage 23 upward and downward along a direction (height direction or Z direction) indicated by arrow Z. Likewise, a motor 28 moves the fabrication stage 24 upward and downward along the Z direction.

The flattening roller 12 is an example of a roller device. The flattening roller 12 supplies the powder 20 supplied onto the supply stage 23 in the supply chamber 21 to the fabrication chamber 22 and flattens the powder 20 in the fabrication chamber 22 to form the powder layer 31. The flattening roller 12 is disposed along a direction (X direction) indicated by arrow X in FIG. 4, which is a direction along a stage surface (a surface on which the powder 20 is stacked) of the fabrication stage 24. A reciprocal moving assembly 25 reciprocally moves the flattening roller 12 relative to the stage surface of the fabrication chamber 22 in a direction (Y direction) indicated by arrow Y in FIG. 4. A motor 26 rotates the flattening roller 12 in a counter direction to the moving direction of the flattening roller 12.

The fabrication unit 5 includes a liquid discharge unit 50 that selectively discharges any of a plurality of fabrication liquids 10 to a selected portion of the powder layer 31 on the fabrication stage 24 to form the fabrication layer 30. The liquid discharge unit 50 includes a carriage 51 and two liquid discharge heads 52a and 52b (hereinafter referred to as simply “head(s) 52” unless distinguished) mounted on the carriage 51. In FIG. 1, the two liquid discharge heads 52 are illustrated. However, in other embodiments, the number of liquid discharge heads may be one, or three or more.

The carriage 51 is movably supported by guides 54 and 55. The guides 54 and 55 are held by side plates 70 on both sides so as to be movable up and down. An X-direction scanning assembly 550 (see FIG. 6) described later reciprocally moves the carriage 51 in the X direction. The X-direction scanning assembly 550 includes a motor, a pulley, and a belt. The X direction is the same as the main scanning direction.

Each of the two heads 52a and 52b includes two nozzle rows, each including a plurality of nozzles arrayed to discharge liquid. Two nozzle rows of one head 52a discharge, for example, fabrication liquid A and fabrication liquid B. Two nozzle rows of the other head 52b discharge, for example, fabrication liquid C and fabrication liquid D. Note that the configuration of the head 52 is not limited to the above-described configuration. The composition of the fabrication liquid is not limited, and the fabrication liquids A, B, C, and D may be the same or may be a combination of liquids including different cross-linkers (crosslinker-containing liquids). A plurality of tanks 60 is mounted on a tank mount 56 and stores the fabrication liquid A, the fabrication liquid B, the fabrication liquid C, and the fabrication liquid D, respectively. The fabrication liquids A, B, C, and D are supplied to the heads 52a and 52b via supply tubes.

The carriage 51 integrally includes a post powder supply unit that supplies powder 20 to at least a portion to which fabrication liquid 10 has adhered when one fabrication layer 30 is formed in the fabrication chamber 22. Further, a maintenance assembly 61 for maintaining and recovering the heads 52 of the liquid discharge unit 50 is disposed on one side (right side in FIG. 1) in the X direction. The maintenance assembly 61 includes caps 62 and a wiper 63. The cap 62 is brought into close contact with the nozzle surface (a surface on which the nozzles are formed) of the head 52, and sucks fabrication liquid 10 from the nozzles to discharge high-viscosity fabrication liquid 10 and powder 20 clogging the nozzles. Then, the wiper 63 wipes the nozzle surface to form meniscus of fabrication liquid 10 in the nozzles, in which the pressure is negative. When the fabrication liquid 10 is not discharged, the maintenance assembly 61 covers the nozzle surfaces of the heads 52 with the caps 62 to prevent powder 20 from entering the nozzles and the fabrication liquid 10 from drying.

The fabrication unit 5 includes a slider 72 slidably supported by a guide 71 above a base 7. The entire fabrication unit 5 is reciprocally movable in the Y direction (sub-scanning direction) perpendicular to the X direction. A Y-direction scanning assembly 552 described later reciprocally moves the entire fabrication unit 5 in the Y direction. The liquid discharge unit 50 is movable upward and downward in the Z direction together with the guides 54 and 55. A Z-direction elevating assembly 551 described later raises and lowers the liquid discharge unit 50 in the Z direction.

The powder chamber 11 has a box shape and includes two chambers, the supply chamber 21 and the fabrication chamber 22, each of which is open at the upper side thereof. The supply stage 23 vertically movable inside the supply chamber 21, and the fabrication stage 24 vertically movable inside the fabrication chamber 22. The relation between a powder amount a1 supplied from the supply chamber 21 and a volume (powder amount a2) of the fabrication chamber 22 satisfies an expression “a1×1.01>a2.” Side surfaces of the supply stage 23 contact inner side surfaces of the supply chamber 21. Side surfaces of the fabrication stage 24 contact inner side surfaces of the fabrication chamber 22. The upper surfaces of the supply stage 23 and the fabrication stage 24 are kept horizontal.

As illustrated in FIG. 5, a powder falling groove 29 is disposed around the powder chamber 11 and has a recessed shape which is open at the upper side thereof. When powder 20 is supplied by the flattening roller 12 to form the powder layer 31, a part of the powder 20 is surplus, and the surplus powder falls into the powder falling groove 29. The surplus powder fallen into the powder falling groove 29 is returned to a powder supply device 554 (see FIG. 6) to supply the powder 20 to the supply chamber 21. The powder supply device 554 is disposed above the supply chamber 21. The powder supply device 554 supplies powder 20 in a tank of the powder supply device 554 to the supply chamber 21 at the time of an initial operation of a fabrication process or when an amount of the powder 20 in the supply chamber 21 decreases. Examples of a method of a powder conveyance for supplying the powder 20 include a screw conveyor system using a screw and an air conveyance system using air.

The flattening roller 12 transfers and supplies powder 20 from the supply chamber 21 to the fabrication chamber 22 and smooths and flattens the surface of the powder 20 to form the powder layer 31 as a layered powder having a desired thickness. The flattening roller 12 has a rod shape longer than an inside dimension of the fabrication chamber 22 and the supply chamber 21 (that is, a width of a portion to which the powder 20 is supplied or stored). The reciprocal moving assembly 25 reciprocally moves the flattening roller 12 in the Y direction (sub-scanning direction) along the stage surface. The flattening roller 12 horizontally moves to pass through an area above the supply chamber 21 and the fabrication chamber 22 from an outside of the supply chamber 21 while being rotated by the motor 26. Accordingly, the powder 20 is transferred and supplied into the fabrication chamber 22, and the flattening roller 12 flattens the powder 20 while passing over the fabrication chamber 22, thus forming the powder layer 31.

Further, as illustrated in FIG. 2, a powder removal plate 13 contacts the circumferential surface of the flattening roller 12 to remove powder 20 adhering to the flattening roller 12. The powder removal plate 13 moves together with the flattening roller 12 while contacting the circumferential surface of the flattening roller 12, thereby removing the powder 20 adhering to the flattening roller 12. In the present embodiment, the powder chamber 11 of the fabrication section 1 includes two chambers of the supply chamber 21 and the fabrication chamber 22. Alternatively, the powder chamber 11 may include only the fabrication chamber 22, and powder 20 may be supplied from the powder supply device 554 to the fabrication chamber 22 and flattened by the flattening roller 12.

FIG. 6 is a block diagram of the three-dimensional fabrication apparatus 601 according to the first embodiment. As illustrated in FIG. 6, a controller 500 includes a main control unit 500A including a central processing unit (CPU) 501, a read only memory (ROM) 502, and a random access memory (RAM) 503. The CPU 501 controls the entire system of the three-dimensional fabrication apparatus 601. The ROM 502 stores programs, which include a program to cause the CPU 501 to perform the control of fabricating a three-dimensional object, and other fixed data. The RANI 503 temporarily stores fabrication data and the like. The controller 500 further includes a nonvolatile RAM (NVRAM) 504 that holds data while the apparatus is powered off. The controller 500 further includes an application specific integrated circuit (ASIC) 505 to perform image processing in which various signals are processed on image data and processing of input and output signals for controlling the entire apparatus.

The controller 500 further includes an external interface (I/F) 506 to send and receive data and signals used when the controller 500 receives fabrication data from a fabrication data generating apparatus 600 (an external device). The fabrication data generating apparatus 600 generates fabrication data in which a final-form object (three-dimensional object) is sliced in multiple fabrication layers. A data processor such as a personal computer is used as the fabrication data generating apparatus 600. The controller 500 further includes an input-output (I/O) unit 507 to receive detection signals of various sensors.

The controller 500 further includes a head drive control unit 508 to control driving of the head 52 of the liquid discharge unit 50. The controller 500 further includes a motor driver 510 that drives a motor included in the X-direction scanning assembly 550 and a motor driver 512 that drives a motor included in the Y-direction scanning assembly 552. The X-direction scanning assembly 550 moves the carriage 51 of the liquid discharge unit 50 in the X direction (main scanning direction). The Y-direction scanning assembly 552 moves the fabrication unit 5 in the Y direction (sub-scanning direction). The controller 500 further includes a motor driver 511 that drives a motor included in the Z-direction elevating assembly 551. The Z-direction elevating assembly 551 moves (raises and lowers) the carriage 51 of the liquid discharge unit 50 in the Z direction. The Z-direction elevating assembly 551 may move (raises and lowers) the entire fabrication unit 5 in the Z-direction.

The controller 500 further includes a motor driver 513 that drives the motor 27 for raising and lowering the supply stage 23 and a motor driver 514 that drives the motor 28 for raising and lowering the fabrication stage 24. The controller 500 further includes a motor driver 515 that drives a motor 553 of the reciprocal moving assembly 25 for moving the flattening roller 12 and a motor driver 516 that drives a motor 26 for rotating the flattening roller 12.

The controller 500 further includes a supply system driver 517 that drives the powder supply device 554 that supplies powder 20 to the supply chamber 21 and a maintenance driver 518 that drives the maintenance assembly 61 of the liquid discharge unit 50. Detected signals of a temperature and humidity sensor 560 that detects the temperature and the humidity as the environment condition of the apparatus and detected signals of other sensors are input into the I/O unit 507 of the controller 500. The controller 500 is connected to a control panel 522 to input and display data necessary for the apparatus. The fabrication data generating apparatus 600 and the three-dimensional fabrication apparatus (powder lamination fabrication apparatus) 601 constitute a three-dimensional fabrication system.

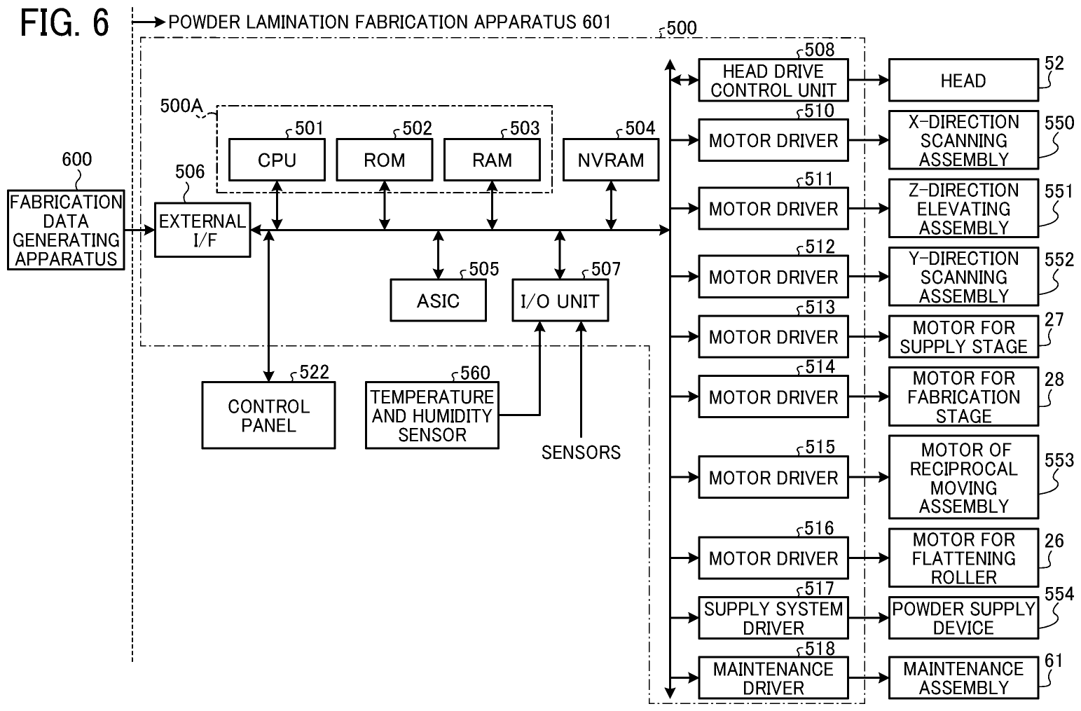

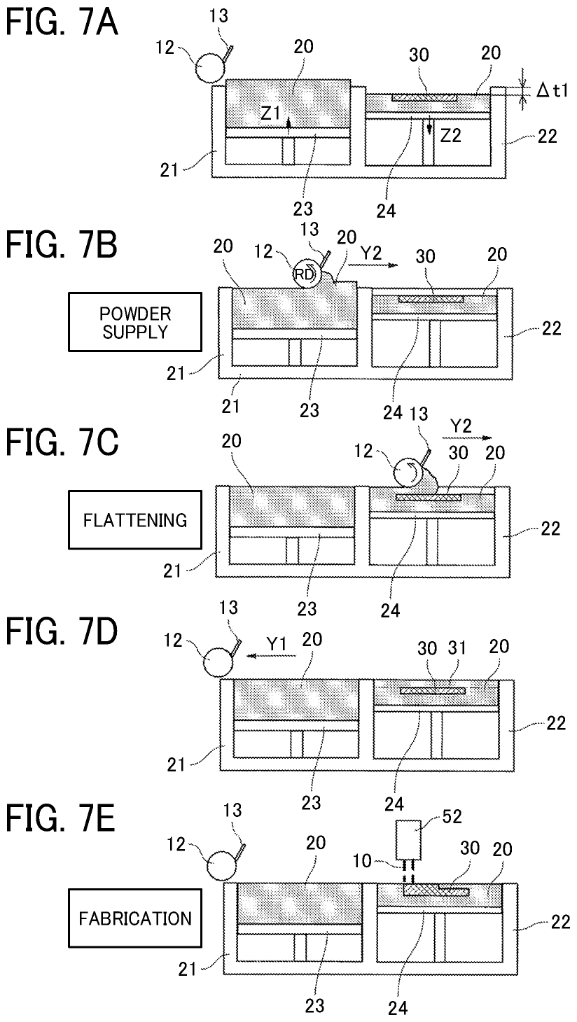

FIGS. 7A to 7E are schematic views illustrating an operation of fabricating a three-dimensional object in the three-dimensional fabrication apparatus 601 according to the first embodiment. FIG. 7A illustrates a state in which a first fabrication layer 30 has been formed on the fabrication stage 24 of the fabrication chamber 22. When a second fabrication layer 30 is formed on the first fabrication layer 30, as illustrated in FIG. 7A, the supply stage 23 of the supply chamber 21 is raised in a direction indicated by arrow Z1, and the fabrication stage 24 of the fabrication chamber 22 is lowered in a direction indicated by arrow Z2.

At this time, a lowering distance of the fabrication stage 24 is set so that a distance between an upper surface of the fabrication chamber 22 (surface of powder 20) and a lower end of the flattening roller 12 (lower tangent portion) becomes Δt1. The distance Δt1 corresponds to the thickness of the powder layer 31 to be subsequently formed. As an example, the distance Δt1 is about several tens μm to about 100 μm.

Next, as illustrated in FIG. 7B, the flattening roller 12 transfers powder 20 upper than the level of an upper surface of the supply chamber 21 in a direction indicated by arrow Y2 toward the fabrication chamber 22 while rotating in the counter direction indicated by arrow RD. Thus, the powder 20 is transferred and supplied into the fabrication chamber 22 (powder supply).

Next, as illustrated in FIG. 7C, the flattening roller 12 moves in parallel to the stage surface of the fabrication stage 24 of the fabrication chamber 22, thereby forming a powder layer 31 having a predetermined distance (thickness) Δt1 over the fabrication layer 30 on the fabrication stage 24 as illustrated in FIG. 7D (flattening). After the powder layer 31 is formed, the flattening roller 12 moves in a direction indicated by arrow Y1 and returns to the initial position as illustrated in FIG. 7D.

The flattening roller 12 is movable while maintaining a constant distance from the level of the upper surface of the fabrication chamber 22 and the supply chamber 21. Such a configuration can form the powder layer 31 with a uniform thickness Δt1 on the fabrication stage 24 of the fabrication chamber 22 or on the fabrication layer 30 already formed on the fabrication stage 24 while transferring the powder 20 to an area above the fabrication chamber 22 with the flattening roller 12.

Then, as illustrated in FIG. 7E, the heads 52 of the liquid discharge unit 50 discharges droplets of the fabrication liquid 10 to form and laminate the next fabrication layer 30 in the powder layer 31 (fabrication). As the fabrication liquid 10 discharged from the head 52 is mixed with the powder 20, adhesives contained in the powder 20 are dissolved, and the dissolved adhesives are bonded together to bind the powder 20, thereby forming the fabrication layer 30.

Next, the step of forming the powder layer 31 by the above-described powder supply and flattening processes and the step of discharging the fabrication liquid 10 with the heads 52 are repeated to form a new fabrication layer 30. At this time, the newly-formed fabrication layer 30 and the preceding fabrication layer 30 are united to form a part of a three-dimensional fabrication object. Then, the step of forming the powder layer 31 by the powder supply and flattening processes and the step of discharging the fabrication liquid 10 with the heads 52 are repeated a required number of times to finish the three-dimensional object (solid object).

Next, examples of a powder material for the three-dimensional fabrication (powder 20) and fabrication liquid 10 used in the three-dimensional fabrication apparatus 601 are described. The powder 20 and the fabrication liquid 10 are not limited to the examples described below.

The powder material for the three-dimensional fabrication includes a base material and a soluble organic material. The base material is coated with the soluble organic material having the average thickness of 5 nm to 1000 nm. The soluble organic material is dissolved and become cross-linkable by the effect of the crosslinker-containing liquid as fabrication liquid. Accordingly, when the crosslinker-containing liquid is applied to the soluble organic material, the soluble organic material is dissolved, and cross-linked by the effect of the cross-linker contained in the crosslinker-containing liquid.

Thus, as a thin layer (powder layer 31) is formed of the above-described powder material for the three-dimensional fabrication and the crosslinker-containing liquid as fabrication liquid 10 is discharged onto the powder layer 31, the dissolved soluble organic material is cross-linked in the powder layer 31, and the powder layer 31 is bonded and cured, thereby forming the fabrication layer 30. At this time, the base material is coated with the soluble organic material having the average thickness of 5 nm to 1000 nm. Therefore, when the soluble organic material is dissolved, the minimum amount of the soluble organic material required for the three-dimensional fabrication is present around the base material, and the soluble organic material is cross-linked to form a three-dimensional network. As a result, the powder layer 31 is cured with high dimensional accuracy and good strength. By repeating the above-described steps, a complicated three-dimensional object can be formed simply and efficiently with high dimensional accuracy without being out of shape before sintering or the like.

The soluble organic material may be present in powder 20, and the fabrication liquid 10 is applied to the powder 20 to cross-link the soluble organic material, thereby forming a three-dimensional object. Alternatively, the soluble organic material may be mixed with the base material instead of coating the base material with the soluble organic material. In another embodiment, powder 20 may include only the base material, and the fabrication liquid 10 containing the soluble organic material may be applied to the powder 20, thereby forming a three-dimensional object.

The base material is not particularly limited as long as the base material has a form of powder or particles, and can be appropriately selected according to the purpose. Examples of the base material include metals, ceramics, carbon, polymers, and the like. From the viewpoint of obtaining a three-dimensional object having high strength, metals and ceramics that can be finally sintered are preferable. Preferred examples of the metals include Steel Special Use Stainless (SUS), iron, copper, titanium, silver, and aluminum, and examples of SUS include SUS316L and the like. Examples of the ceramics include metal oxide and the like. Specifically, examples of the metal oxide include silica (SiO₂), alumina (Al₂O₃), zirconia (ZrO₂), titania (TiO₂), and the like. Examples of the carbon include graphite, graphene, carbon nanotubes, carbon nanohorns, and fullerene. Each of these materials can be used alone or in combination with others. In addition, the surface of the base material may be modified by a certain surface treatment to improve the affinity for the soluble organic material.

As the soluble organic material, a material having a property of being dissolved in the fabrication liquid 10 and being cross-linkable by the effect of the cross-linker can be used. In other words, the soluble organic material is not particularly limited and may be appropriately selected according to the purpose as long as the soluble organic material is soluble in the fabrication liquid 10 and cross-linkable by the cross-linker. As the soluble organic material, for example, polyvinyl alcohol, polyacrylic acid, or the like can be used.

The crosslinker-containing liquid as fabrication liquid is not particularly limited as long as the liquid includes a cross-linker in a liquid medium thereof, and may be appropriately selected according to the purpose. In addition to the liquid medium and the cross-linker, the crosslinker-containing liquid may contain other components appropriately selected as necessary. The other components can be appropriately selected in consideration of various conditions such as the type of a device for applying the crosslinker-containing liquid, frequency of use, and an amount of the crosslinker-containing liquid. For example, when the crosslinker-containing liquid is applied by a liquid discharge method, the crosslinker-containing liquid can be selected in consideration of the influence of clogging or the like of the nozzles of the liquid discharge head 52.

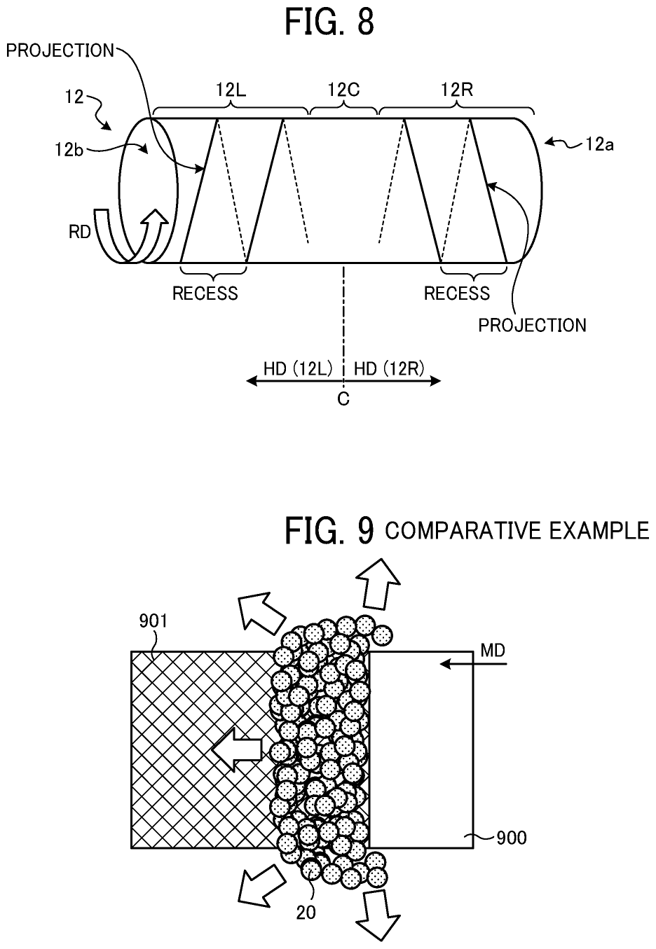

FIG. 8 is a perspective view of the flattening roller 12. As illustrated in FIG. 8, the flattening roller 12 has a first end region 12R (right end region) adjacent to a first end 12a (right end in FIG. 8), a second end region 12L (left end region) adjacent to a second end 12b (left end in FIG. 8), and a center region 12C. The center region 12C is disposed at the center C of the flattening roller 12 and has a length set within a range of 1/10 to ½ of a contact length where the flattening roller 12 contacts powder 20 in a longitudinal direction of the flattening roller 12. A groove is not disposed in the center region 12C. The center region 12C is an example of a groove-less portion without a groove.

The flattening roller 12 includes a helical groove in the right-handed screw direction (helical direction) in the first end region 12R as indicated by arrow HD (12R) in FIG. 8. The helical groove has a recessed shape. The flattening roller 12 further includes a helical groove in the left-handed screw direction (helical direction) in the second end region 12L as indicated by arrow HD (12L) in FIG. 8. The helical groove has a recessed shape. That is, the grooves (the helical groove in the right-handed screw direction and the helical groove in the left-handed screw direction) of the flattening roller 12 are line-symmetric with respect to the center C of the longitudinal axis of the flattening roller 12.

When the flattening roller 12 rotates in a direction indicated by arrow RD in FIG. 8 while contacting powder 20, the grooves in the first end region 12R and the second end region 12L move the powder 20 toward the first end 12a and the second end 12b, respectively. The “projected portion” illustrated in FIG. 8 may project from the flattening roller 12 or may be at the same height as the surface of the flattening roller 12.

That is, the flattening roller 12 includes a first helical groove region on the right side in FIG. 8 and a second helical groove region on the left side in FIG. 8 with respect to the center C as a boundary. The first helical groove region includes the first end region 12R including a first groove, and the second helical groove region includes the second end region 12L including a second groove. Further, the first helical groove region includes a part of the center region 12C that is the groove-less portion, and the second helical groove region includes a part of the center region 12C that is the groove-less portion. The grooves of the flattening roller 12 are line-symmetric with respect to the center C of the longitudinal axis of the flattening roller 12. As a result, the flattening roller 12 can prevent powder 20 from being unevenly distributed and from running short.

If a helical interval of the groove of the flattening roller 12 is too large, powder 20 may clog the groove and it may be difficult to move the powder 20 toward the ends of the flattening roller 12. On the other hand, if the helical interval of the groove of the flattening roller 12 is narrow, powder 20 is moved only a short distance per rotation of the flattening roller 12. Thus, it may be difficult to move a large amount of the powder 20. For this reason, in the three-dimensional fabrication apparatus 601 according to the first embodiment, the helical interval of the groove of the flattening roller 12 is within a range of from 1/20 of the diameter of the flattening roller 12 to the diameter of the flattening roller 12.

If the depth D of the groove of the flattening roller 12 is equal to or less than D50, which is the median diameter of powder 20, the flattening roller 12 does not have sufficient ability to move the powder 20. If the depth D of the groove of the flattening roller 12 is equal to or more than D50×1000, a visible trace of the groove is clearly formed on the surface of the powder 20, thereby deteriorating the quality of fabrication. Therefore, the flattening roller 12 includes the groove with the depth D that is equal to or greater than D50 of the powder 20 and equal to or smaller than D50×1000.

If the width of the groove of the flattening roller 12 is set to 1/10 or less of the helical interval, the movement amount of powder 20 may be reduced. If the width of the groove of the flattening roller 12 is set to ½ or more of the helical interval, which is too wide, the groove is less likely affect powder 20, and the movement amount of the powder 20 may be reduced. Therefore, the flattening roller 12 includes the groove with the width within a range of 1/10 to ½ of the helical interval.

If the rotation speed of the flattening roller 12 is low, it may be difficult to sufficiently spread powder 20. If the rotation speed of the flattening roller 12 is high, the flattening roller 12 may scatter more powder 20, and the surface of the powder 20 may become rough. Therefore, in the three-dimensional fabrication apparatus 601 according to the first embodiment, the CPU 501 and the motor driver 516 illustrated in FIG. 6 control the rotation speed of the flattening roller 12 in a range of 1 revolution per minute (rpm) to 1000 rpm.

A linear speed difference is required between the surface of powder 20 and the surface of the flattening roller 12 as a recoater. If the flattening roller 12 rotates faster than the moving speed of the flattening roller 12 in the forward direction with respect to the moving direction to obtain the linear speed difference, the flattening roller 12 scrapes the powder 20 backward, and the surface of the powder 20 may become rough. For this reason, in the first embodiment, the CPU 501 and motor driver 516 illustrated in FIG. 6 cause the flattening roller 12 to rotate in the reverse direction (rotation in the counter direction) with respect to the moving direction as illustrated in FIG. 7B. Thus, the linear speed difference can be easily obtained. The CPU 501 and the motor driver 516 are examples of a rotation driver.

In addition, when the moving speed of the flattening roller 12 is low, it takes time to perform the fabrication operation, and the productivity may decrease. On the other hand, when the moving speed of the flattening roller 12 is high, it may be difficult to sufficiently spread powder 20, and flattening roller 12 may scatter more powder 20. Therefore, the CPU 501 and the motor driver 515 illustrated in FIG. 6 serve as a movement driver of the flattening roller 12 and control the moving speed of the flattening roller 12 in a range of 1 mm/s to 1000 mm/s.

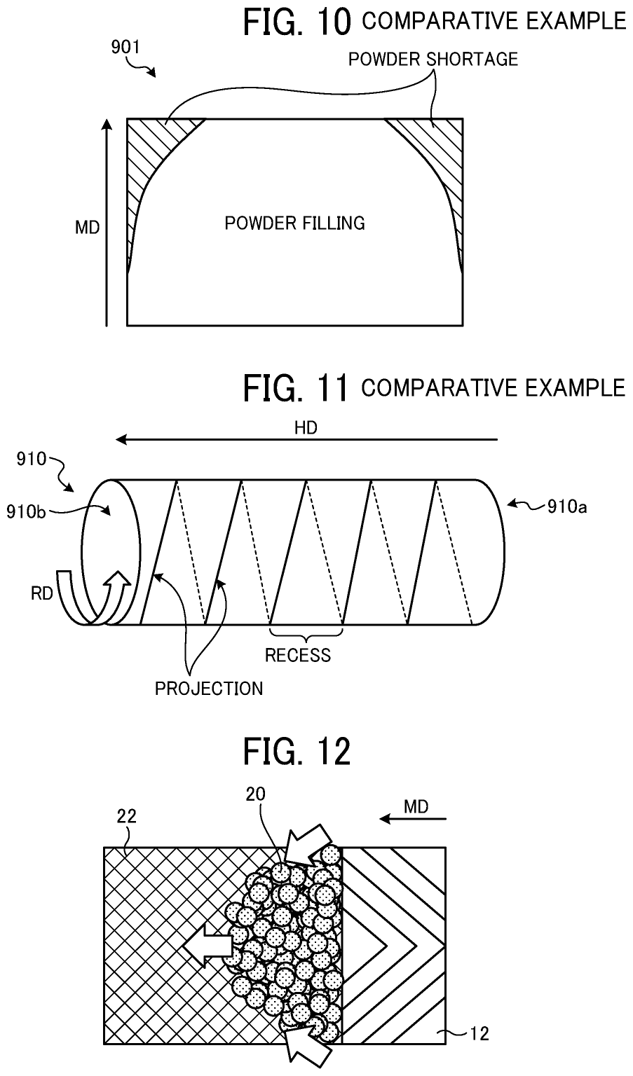

FIG. 9 is a schematic view illustrating a state in which a flattening roller 900 without a groove according to a first comparative example flattens powder 20. In the case of the flattening roller 900 without the groove, as illustrated in FIG. 9, when the flattening roller 900 moves on a fabrication chamber 901 in the moving direction indicated by arrow MD, a large amount of surplus powder is discharged to the outside of the fabrication chamber 901 through both ends thereof (generation of waste powder). On the other hand, the powder 20 sufficiently remains in the center region of the flattening roller 900 and is flatten by the flattening roller 900. As a result, as illustrated in FIG. 10, the powder 20 fills the center portion of the fabrication chamber 901 and runs short near the left and right ends of the fabrication chamber 901 in FIG. 10 (powder shortage).

FIG. 11 is a perspective view of a flattening roller 910 according to a second comparative example. The flattening roller 910 includes a helical groove in the left-handed screw direction disposed from the right end 910a to the left end 910b in FIG. 11. In the case of the flattening roller 910, since powder 20 is conveyed only in one direction, the powder 20 is unevenly distributed along the longitudinal axis of the flattening roller 910, thereby generating surplus powder.

On the other hand, in the case of the three-dimensional fabrication apparatus 601 according to the first embodiment, as the flattening roller 12 moves on the fabrication chamber 22 while rotating, powder 20 unevenly distributed near the center C of the flattening roller 12 is moved toward the first end 12a and the second end 12b and flatten in the fabrication chamber 22. As a result, when the powder 20 is scraped off by the flattening roller 12 (scraping process), surplus powder can be reduced, and the fabrication chamber 22 can be evenly filled with the powder 20 at the center C, near the first end 12a, and near the second end 12b. In other words, the scraping process, in which the flattening roller 12 evenly distributes and flattens the powder 20 in the entire fabrication chamber 22, can be implemented while minimizing the surplus powder.

A second embodiment is described below. The three-dimensional fabrication apparatus 601 according to the second embodiment is described below. Note that the second embodiment described below is different only in the shape of the groove of the flattening roller 12 from the first embodiment described above. Therefore, only the flattening roller 12 is described below, and redundant description is omitted.

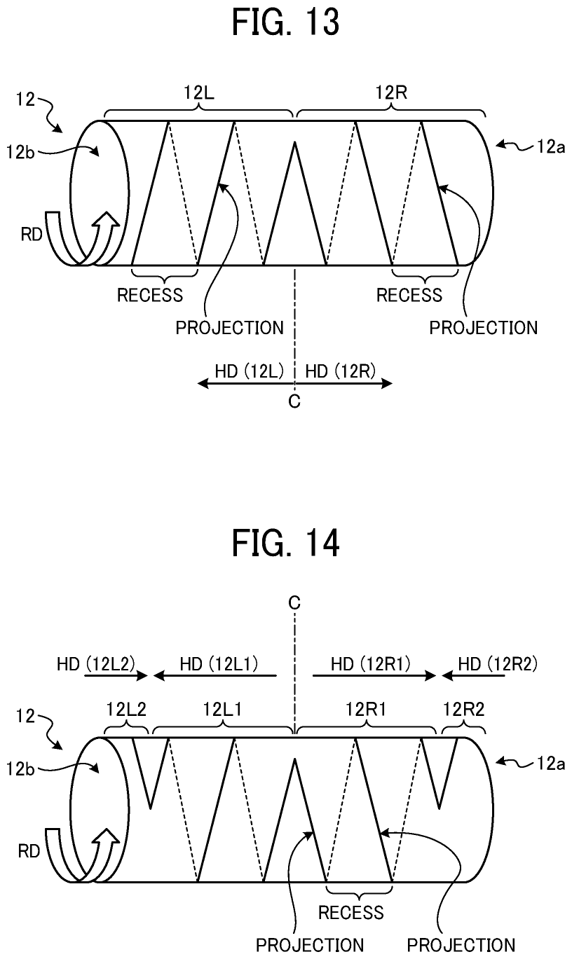

FIG. 13 is a perspective view of a flattening roller 12 of the three-dimensional fabrication apparatus 601 according to the second embodiment. The flattening roller 12 described in the first embodiment has the center region 12C that is the groove-less portion (see FIG. 8). On the other hand, in the second embodiment, as illustrated in FIG. 13, the groove is disposed in a portion corresponding to the center region 12C in the first embodiment.

That is, in the second embodiment, the flattening roller 12 includes a helical groove in the right-handed screw direction in the first end region 12R that is on the right side in FIG. 13 with respect to the center C of the longitudinal axis of the flattening roller 12. The helical groove has a recessed shape. The flattening roller 12 further includes a helical groove in the left-handed screw direction in the second end region 12L that is on the left side in FIG. 13 with respect to the center C of the longitudinal axis of the flattening roller 12. The helical groove has a recessed shape.

Thus, as the flattening roller 12 contacts powder 20 while rotating, the groove in the first end region 12R moves powder 20 toward the first end 12a and the groove in the second end region 12L moves powder 20 toward the second end 12b with respect to the center C of the longitudinal axis of the flattening roller 12, thereby flattening the powder 20. Therefore, effects similar to the first embodiment described above can be attained.

A third embodiment is described below. The three-dimensional fabrication apparatus 601 according to the third embodiment is described below. Note that the third embodiment described below is different only in the shape of the groove of the flattening roller 12 from the embodiments described above. Therefore, only the flattening roller 12 is described below, and redundant description is omitted.

FIG. 14 is a perspective view of a flattening roller 12 of the three-dimensional fabrication apparatus 601 according to the third embodiment. The flattening roller 12 described in the second embodiment includes the helical groove in the right-handed screw direction in the first end region 12R and the helical groove in the left-handed screw direction in the second end region 12L across the center C of the longitudinal axis of the flattening roller 12.

In the third embodiment, the grooves of the flattening roller 12 are line-symmetric with respect to the center C of the longitudinal axis of the flattening roller 12. The flattening roller 12 includes a helical groove in the left-handed screw direction in a second end region 12L1 that is on the left side in FIG. 14 with respect to the center C. The flattening roller 12 further includes a helical groove in the right-handed screw direction in a first end region 12R1 that is on the right side in FIG. 14 with respect to the center C. This configuration is the same as the configuration in the second embodiment described above.

In addition, in the third embodiment, the flattening roller 12 further includes another groove in helical direction in a first end region 12R2 outboard of the groove in the first end region 12R1 and adjacent to the first end 12a. The helical direction of the groove in the first end region 12R2 is opposite to the helical direction (right-handed screw direction) of the groove in the first end region 12R1. That is, the helical direction of the groove in the first end region 12R1 is the right-handed screw direction, and the helical direction of the groove in the first end region 12R2 is the left-handed screw direction. Similarly, another groove in a second end region 12L2 is disposed outboard of the groove in the second end region. The helical direction of the groove in the second end region 12L1 is the left-handed screw direction, and the helical direction of the groove in the second end region 12L2 is the right-handed screw direction.

In other words, the length of the flattening roller 12 in the longitudinal direction is slightly longer than the width of the fabrication chamber 22. As the groove in the second end region 12L1 of the flattening roller 12 moves powder 20 in the fabrication chamber 22 from the center C toward the second end 12b, surplus powder is discharged from an end of the fabrication chamber 22 corresponding to the second end 12b. Similarly, as the groove in the first end region 12R1 of the flattening roller 12 moves powder 20 in the fabrication chamber 22 from the center C toward the first end 12a, surplus powder is discharged from an end of the fabrication chamber 22 corresponding to the first end 12a.

In addition, in the third embodiment, the groove in the second end region 12L2 of the flattening roller 12 returns the surplus powder discharged from the end of the fabrication chamber 22 corresponding to the second end 12b into the fabrication chamber 22. Similarly, the groove in the first end region 12R2 of the flattening roller 12 returns the surplus powder discharged from the end of the fabrication chamber 22 corresponding to the first end 12a into the fabrication chamber 22. That is, the grooves in the first end region 12R2 and the second end region 12L2 move powder 20 in directions opposite to the directions of movement of the powder 20 by the grooves in the first end region 12R1 and the second end region 12L1, respectively.

As a result, the surplus powder discharged out of the fabrication chamber 22 can be reduced, and the powder 20 can be effectively used. Therefore, the powder shortage described with reference to FIG. 10 can be prevented with a smaller amount of powder 20, and effects similar to those of the above-described embodiments can be attained.

A fourth embodiment is described below. The three-dimensional fabrication apparatus 601 according to the fourth embodiment is described below. Note that the fourth embodiment described below is different only in the shape of the groove of the flattening roller 12 from the above-described embodiments. Therefore, only the flattening roller 12 is described below, and redundant description is omitted.

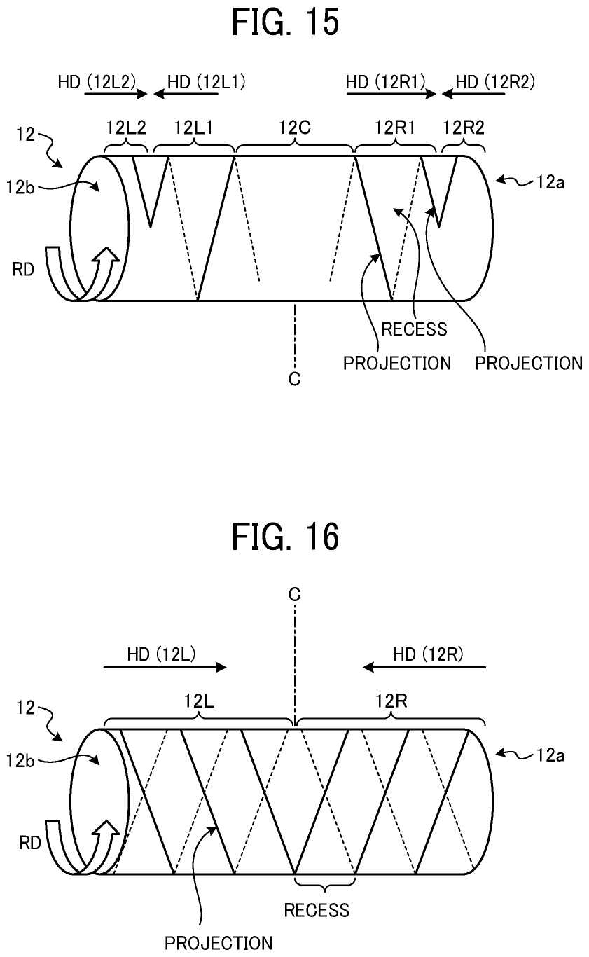

FIG. 15 is a perspective view of a flattening roller 12 of the three-dimensional fabrication apparatus 601 according to the fourth embodiment. The flattening roller 12 described in the third embodiment includes the grooves having the different helical directions on both sides across the center C of the longitudinal axis of the flattening roller 12.

The flattening roller 12 according to the fourth embodiment has the center region 12C without a groove in addition to the configuration described in the third embodiment. In the fourth embodiment, as described in the third embodiment, the grooves in the first end region 12R2 and the second end region 12L2 adjacent to the first and second ends 12a and 12b return the surplus powder into the fabrication chamber 22. In addition, since the flattening roller 12 has the center region 12C that is the groove-less portion, the groove-less portion can more evenly smooths powder 20 in the center portion of the fabrication chamber 22.

A description is given below of experiment results of the first to fourth embodiments and the first and second comparative examples. Table 1 below illustrates the experiment results of the three-dimensional fabrication apparatuses 601 according to the first to fourth embodiments and the first and second comparative examples described above.

TABLE 1

| | | Surplus/Supply |
|---|---|---|
| | Powder Shortage | Powder Amount |
| | at Both Ends | (%) |
| First Embodiment | none | 5 |
| Second Embodiment | none | 4 |
| Third Embodiment | none | 3 |
| Fourth Embodiment | none | 2 |
| First Comparative Example | occur | 12 |
| Second Comparative Example | none | 10 |

First, as illustrated in Table 1, in the three-dimensional fabrication apparatus 601 including the flattening roller 12 according to the first embodiment illustrated in FIG. 8, powder shortage at both ends of the fabrication chamber 22 described with reference to FIG. 10 does not occur. In the first embodiment, the ratio (%) of the surplus powder to the amount of the supplied powder is 5%. In the first comparative example, the ratio (%) of the surplus powder to the amount of the supplied powder is 12%. In the second comparative example, the ratio (%) of the surplus powder to the amount of the supplied powder is 10%. Thus, in the first embodiment, the surplus powder can be greatly reduced.

Similarly, in the three-dimensional fabrication apparatus 601 including the flattening roller 12 according to the second embodiment illustrated in FIG. 13, powder shortage at both ends of the fabrication chamber 22 described with reference to FIG. 10 does not occur. In the second embodiment, the ratio (%) of the surplus powder to the amount of the supplied powder is 4%. Thus, the surplus powder can be greatly reduced as compared with the first and second comparative examples in which the ratio of the surplus powder is 10% or more.

Similarly, in the three-dimensional fabrication apparatus 601 including the flattening roller 12 according to the third embodiment illustrated in FIG. 14, powder shortage at both ends of the fabrication chamber 22 described with reference to FIG. 10 does not occur. In the third embodiment, the ratio (%) of the surplus powder to the amount of the supplied powder is 3%. Thus, the surplus powder can be greatly reduced as compared with the first and second comparative examples in which the ratio of the surplus powder is 10% or more.

Similarly, in the three-dimensional fabrication apparatus 601 including the flattening roller 12 according to the fourth embodiment illustrated in FIG. 15, powder shortage at both ends of the fabrication chamber 22 described with reference to FIG. 10 does not occur. In the fourth embodiment, the ratio (%) of the surplus powder to the amount of the supplied powder is 2%. Thus, the surplus powder can be greatly reduced as compared with the first and second comparative examples in which the ratio of the surplus powder is 10% or more.

A fifth embodiment is described below. The three-dimensional fabrication apparatus 601 according to the fifth embodiment is described below. Note that the fifth embodiment described below is different only in the shape of the groove of the flattening roller 12 from the above-described embodiments. Therefore, only the flattening roller 12 is described below, and redundant description is omitted.

FIG. 16 is a perspective view of a flattening roller 12 of the three-dimensional fabrication apparatus 601 according to the fifth embodiment. The flattening roller 12 described in each of the above-described embodiments includes the grooves that move powder 20 from the center C of the flattening roller 12 toward the first end 12a or toward the second end 12b.

On the other hand, in the fifth embodiment, the flattening roller 12 includes a helical groove in the left-handed screw direction disposed from the first end 12a to the center C to move powder 20 from the first end 12a toward the center C. The flattening roller 12 further includes a helical groove in the right-handed screw direction disposed from the second end 12b to the center C to move powder 20 from the second end 12b toward the center C.

In this case, as illustrated in FIG. 12, the flattening roller 12 can smooth the powder 20 while returning the powder 20, which is about to be discharged out of the fabrication chamber 22 near the first and second ends 12a and 12b of the flattening roller 12, to the inside of the fabrication chamber 22. Thus, surplus powder discharged from both ends of the fabrication chamber 22 is returned into the fabrication chamber 22, thereby reducing the surplus powder discharged out of the fabrication chamber 22. Therefore, the powder 20 can be effectively used, and the powder shortage described with reference to FIG. 10 can be prevented with a smaller amount of powder 20. Further, effects similar to those of the above-described embodiments can be attained.

A sixth embodiment is described below. The three-dimensional fabrication apparatus 601 according to the sixth embodiment is described below. Note that the sixth embodiment described below is different only in the shape of the groove of the flattening roller 12 from the above-described embodiments. Therefore, only the flattening roller 12 is described below, and redundant description is omitted.

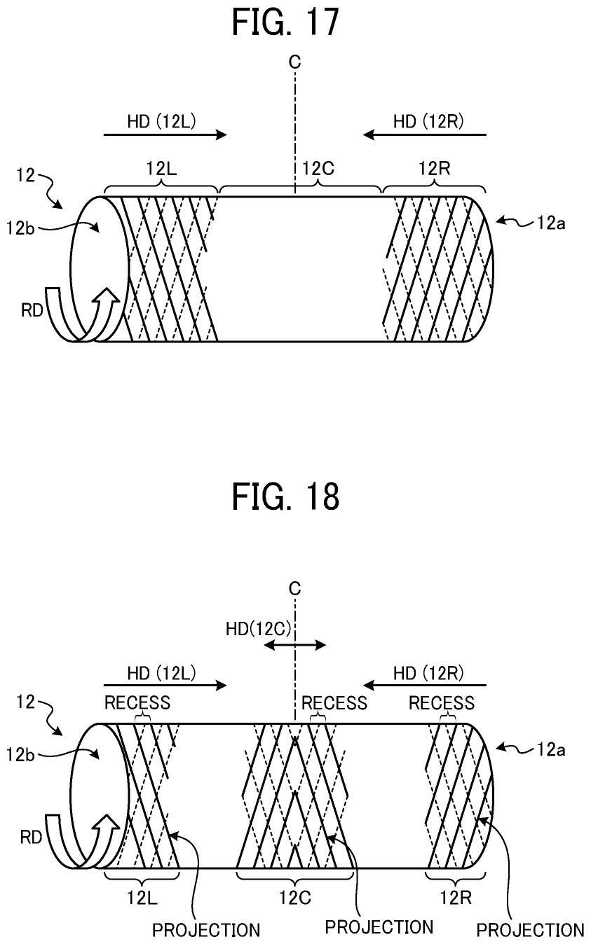

FIG. 17 is a perspective view of a flattening roller 12 of the three-dimensional fabrication apparatus 601 according to the sixth embodiment. The flattening roller 12 described in the fifth embodiment includes the grooves disposed up to the center C. In addition, the flattening roller 12 according to the sixth embodiment has the center region 12C without a groove.

That is, in the sixth embodiment, the flattening roller 12 includes a helical groove in the left-handed screw direction in the first end region 12R adjacent to the first end 12a, a helical groove in the right-handed screw direction in the second end region 12L adjacent to the second end 12b, and a groove-less portion in the center region 12C.

As a result, the flattening roller 12 can smooth powder 20 while moving the powder 20 from the first and second ends 12a and 12b of the flattening roller 12 toward the center region 12C. Therefore, surplus powder discharged from the ends of the fabrication chamber 22 corresponding to the first and second ends 12a and 12b can be returned into the fabrication chamber 22, and the surplus powder discharged out of the fabrication chamber 22 can be reduced. In addition, since the flattening roller 12 has the center region 12C that is the groove-less portion, powder 20 in the fabrication chamber 22 can be more evenly smoothed, and effects similar to those of the above-described embodiments can be attained.

A variation of the sixth embodiment is described below. In the sixth embodiment, the flattening roller 12 includes the helical groove in the left-handed screw direction in the first end region 12R adjacent to the first end 12a and the helical groove in the right-handed screw direction in the second end region 12L adjacent to the second end 12b. In the variation of the sixth embodiment, the flattening roller 12 may include a helical groove in the right-handed screw direction in the first end region 12R adjacent to the first end 12a, a helical groove in the left-handed screw direction in the second end region 12L adjacent to the second end 12b, and a groove-less portion in the center region 12C. In this case, although surplus powder is generated from the center portion of the fabrication chamber 22 corresponding to the center region 12C, the respective grooves in the first and second end regions 12R and 12L of the flattening roller 12 disperse the surplus powder toward the first and second ends 12a and 12b, thereby evenly distributing powder 20 in the fabrication chamber 22. Therefore, the powder shortage near both ends of the fabrication chamber 22 described with reference to FIG. 10 can be prevented, and effects similar to those of the above-described embodiments can be attained.

A seventh embodiment is described below. The three-dimensional fabrication apparatus 601 according to the seventh embodiment is described below. Note that the seventh embodiment described below is different only in the shape of the groove of the flattening roller 12 from the above-described embodiments. Therefore, only the flattening roller 12 is described below, and redundant description is omitted.

FIG. 18 is a perspective view of a flattening roller 12 of the three-dimensional fabrication apparatus 601 according to the seventh embodiment. As illustrated in FIG. 18, in the seventh embodiment, the flattening roller 12 includes a helical groove in the left-handed screw direction in the first end region 12R adjacent to the first end 12a. The flattening roller 12 further includes a helical groove in the right-handed screw direction in the second end region 12L adjacent to the second end 12b. In the center region 12C, the flattening roller 12 further includes a helical groove in the right-handed screw direction on the first end region 12R side and a helical groove in the left-handed screw direction on the second end region 12L side across the center C. Further, in the seventh embodiment, groove-less portions are disposed between first end region 12R and the center region 12C of the flattening roller 12 and between the second end region 12L and the center region 12C.

In the seventh embodiment, the groove in the first end region 12R can return surplus powder discharged from the end of the fabrication chamber 22 corresponding to the first end 12a into the fabrication chamber 22. Similarly, the groove in the second end region 12L can return surplus powder discharged from the end of the fabrication chamber 22 corresponding to the second end 12b into the fabrication chamber 22. Therefore, the surplus powder discharged out of the fabrication chamber 22 can be reduced. In addition, the respective grooves in the center region 12C can move surplus powder in the center portion of the fabrication chamber 22 toward the first and second ends 12a and 12b with respect to the center C as a boundary, thereby evenly distributing and smoothing powder 20 in the fabrication chamber 22. Further, since the flattening roller 12 has the groove-less portions on both sides, the flattening roller 12 can more evenly smooth powder 20 moved from the first and second ends 12a and 12b of the flattening roller 12 toward the center region 12C and powder 20 moved from the center region 12C toward the first and second ends 12a and 12b. In addition, effects similar to those of the above-described embodiments can be attained.

A variation of the seventh embodiment is described below. In the seventh embodiment described above, the flattening roller 12 includes the helical groove in the left-handed screw direction in the first end region 12R and the helical groove in the right-handed screw direction in the second end region 12L. In the variation of the seventh embodiment, the flattening roller 12 may include a helical groove in the right-handed screw direction in the first end region 12R and a helical groove in the left-handed screw direction in the second end region 12L. In this case, the grooves in the first and second end regions 12R and 12L can discharge surplus powder to evenly distribute powder 20 in the fabrication chamber 22, from both ends of the fabrication chamber 22. As a result, the powder 20 can be more evenly distributed in the fabrication chamber 22, and effects similar to those of the above-described embodiments can be attained.

According to the present disclosure, the surplus powder in the scraping process by the recoater can be reduces, and the entire fabrication chamber can be filled with the powder.

Although the exemplary embodiments have been described above, such descriptions are not intended to limit the scope of the present disclosure to the illustrated embodiments. The above-described novel embodiments can be implemented in other various forms, and various omissions, replacements, and changes can be made without departing from the scope of the disclosure. These embodiments and modifications thereof are included in the scope and gist of the present disclosure, and are included in the scope of claims and the equivalent scope thereof.

What is claimed is:

1. A three-dimensional fabrication apparatus comprising:
a fabrication chamber in which powder is spread in layers and fabrication layers are to be laminated, the fabrication layers being formed of the powder bonded together; and
a roller configured to flatten the powder in the fabrication chamber, the roller including:
a first helical groove region including a first groove configured to move the powder in the fabrication chamber in a first direction along a longitudinal axis of the roller as the roller rotates, and
a second helical groove region including a second groove configured to move the powder in the fabrication chamber in a second direction opposite to the first direction as the roller rotates.

2. The three-dimensional fabrication apparatus according to claim 1, further comprising:
a movement driver configured to move the roller in a moving direction perpendicular to the longitudinal axis of the roller along an upper surface of the fabrication chamber; and
a rotation driver configured to rotate the roller in a counter direction with respect to the moving direction of the roller.

3. The three-dimensional fabrication apparatus according to claim 1,
wherein the first helical groove region and the second helical groove region are line-symmetric with respect to a center of the longitudinal axis of the roller.

4. The three-dimensional fabrication apparatus according to claim 3,
wherein the first helical groove region and the second helical groove region are disposed adjacent to a first end and a second end, respectively, of the roller with respect to the center of the longitudinal axis of the roller as a boundary,
wherein the first direction is from the center toward the first end, and
wherein the second direction is from the center toward the second end.

5. The three-dimensional fabrication apparatus according to claim 3,
wherein the first helical groove region and the second helical groove region are disposed adjacent to a first end and a second end, respectively, of the roller with respect to the center of the longitudinal axis of the roller as a boundary,
wherein the first direction is from the first end toward the center, and
wherein the second direction is from the second end toward the center.

6. The three-dimensional fabrication apparatus according to claim 3,
wherein the first helical groove region and the second helical groove region are disposed adjacent to a first end and a second end, respectively, of the roller with respect to the center of the longitudinal axis of the roller as a boundary,
wherein the first helical groove region further includes another first groove configured to move the powder in a direction opposite to the first direction, said another first groove outboard of the first groove, and
wherein the second helical groove region further includes another second groove configured to move the powder in a direction opposite to the second direction, said another second groove outboard of the second groove.

7. The three-dimensional fabrication apparatus according to claim 1,
wherein the roller includes a groove-less portion without a groove, the groove-less portion across a center of the longitudinal axis of the roller.

8. The three-dimensional fabrication apparatus according to claim 1,
wherein the first helical groove region and the second helical groove region are disposed adjacent to a first end and a second end, respectively, of the roller with respect to a center of the longitudinal axis of the roller as a boundary,
wherein the first helical groove region further includes a first groove-less portion without a groove between the center and the first end, and
wherein the second helical groove region further includes a second groove-less portion without a groove between the center and the second end.

9. The three-dimensional fabrication apparatus according to claim 1,
wherein the powder includes coating powder.

10. The three-dimensional fabrication apparatus according to claim 1, further comprising a liquid discharge unit configured to discharge fabrication liquid to a selected portion of the powder to cure and bond the powder.
